(19) United States
(12) Patent Application Publication
(10) Pub. No.: US 2005/0157513 A1
(43) Pub. Date: Jul. 21, 2005

(54) Visible device for laminated automobiles glass

(76) Inventors: Jerry Dewanye Alexander, Memphis, TN (US); Terrance Montrell Alexander, Memphis, TN (US); James Gamble Alexander, Memphis, TN (US)

Correspondence Address: Jerry D. Alexander Sr., 1497 Estill, Memphis, TN, 38109, US

(21) Appl. No.: 10/760,894

(22) Filed: Jan. 20, 2004

(51) Int. Cl. B60Q 1/26

(52) U.S. Cl. 362/503

(57) ABSTRACT

An automobile visible device located inside 1A and 1B which will be operated by illuminate film to illuminate any words inside of windshield glass.

### FIELD OF THE INVENTION

This invention is visible to the human eye and can be used to advertise a trademark name or etc. on the outside of an automobile windshield.

### BACKGROUND OF THE INVENTION

People use automobiles to advertise the name of their business on the side of the automobiles, stick on label, stick on letters at the top of windshield glass or etc. Using this new visible device, you can laminate a illuminate film between the windshield glass to advertise a trademark name, logo or etc. that will flash up top on the outside windshield glass or inside of laminate side automobile glass, showing only on the outside of the glass.

### SUMMARY OF THE INVENTION

This Visible Device is a illuminate film, that can be used to advertise a trademark name or etc., laminated inside the front, rear windshield glass or side laminate glass of an automobile, when automobile glass is being made. Any words will illuminate on the front/rear windshield or laminate side glass when activate by the on switch. This device can be used for business to advertise the name of their firm flashing inside the automobile glass and cabs can illuminate the word (vacant) flashing inside of the windshield glass. There is also the public, people that drive around with logos across the top of their windshield glass. Using this device peoples would be able to illuminate any word inside of the windshield glass or laminate side glass, showing only on the outside of the automobile glass.

### BRIEF DESCRIPTION OF THE DRAWING

FIG. 1. Display one whole windshield glass, completely made.

FIG. 2. Displays two piece interlayer and outlayer of glass for automobiles.

FIG. 3 Shows PVB film and illuminated film.

FIG. 4. Shows glasses 1A and 1B, PVB layer 2, illuminate film 3, wire connector end 4, and magnetic field 5.

FIG. 5. Shows illuminate film 3, control panel 6 and switch 7.

FIG. 6. Displays illuminate film 3, driver 8, passenger 9 and automobile 10.

FIG. 7. Displays side automobile laminate glass 11A & 11B with the illuminate film 3, connector end 4 and magnetic field 5.

FIG. 8. Shows driver 8 using automobile 10 to activate the illuminate film 3 to use to sell fresh vegetable 12.

### DESCRIPTION OF THE PREFERRED EMBODIMENT

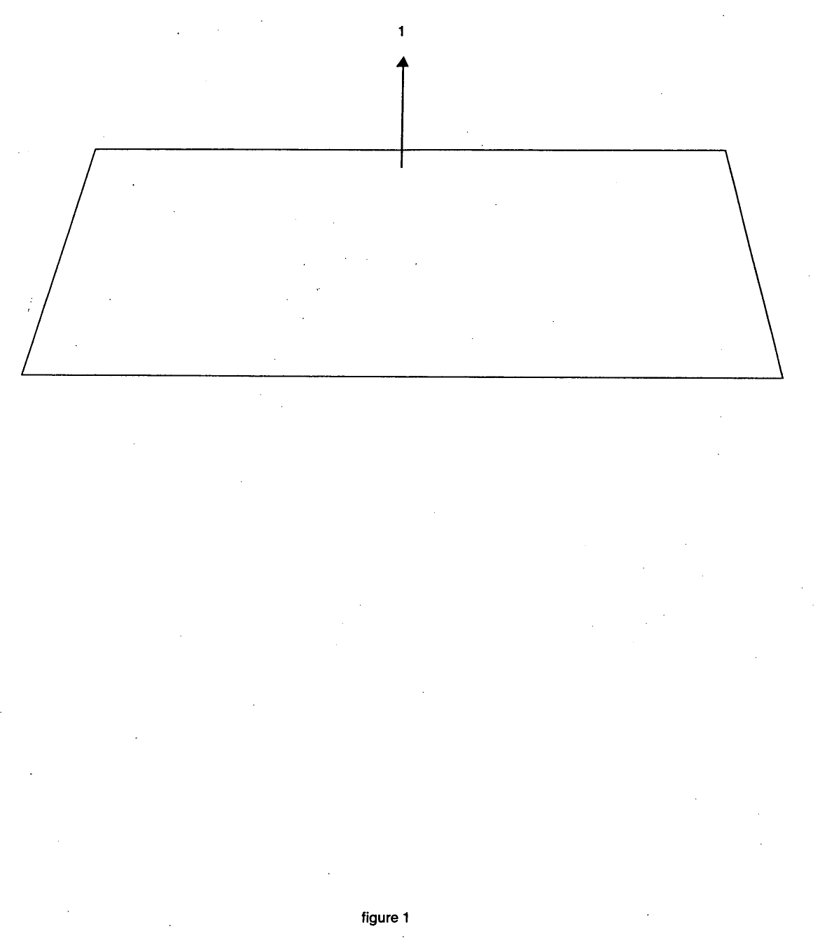

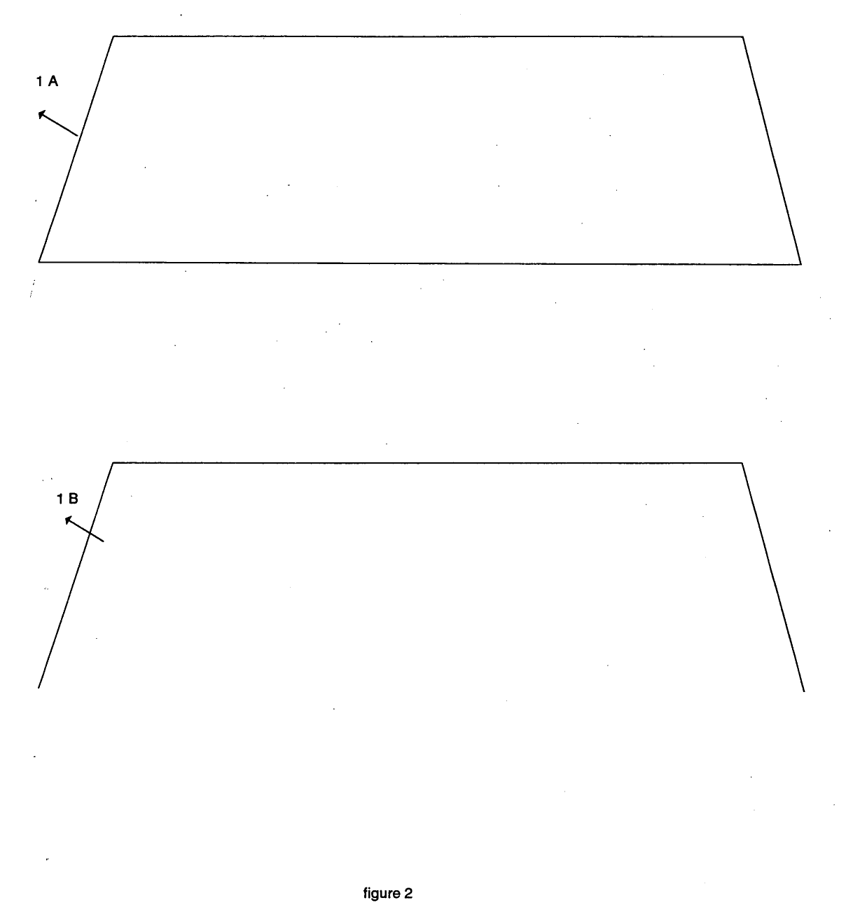

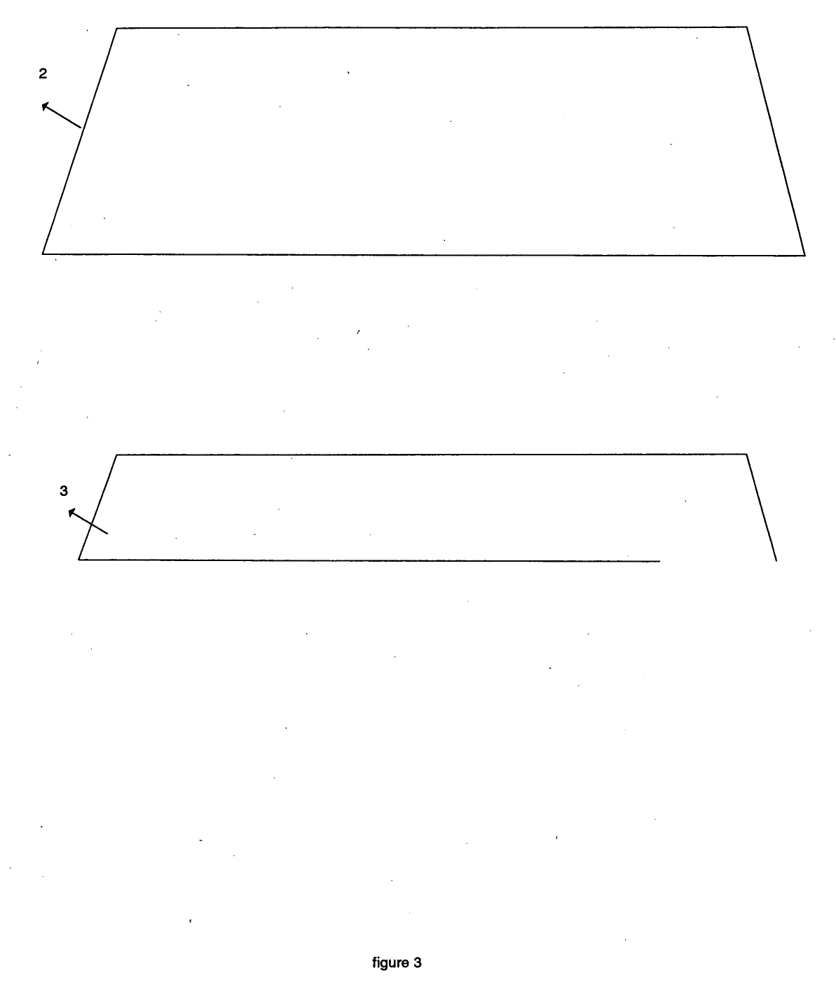

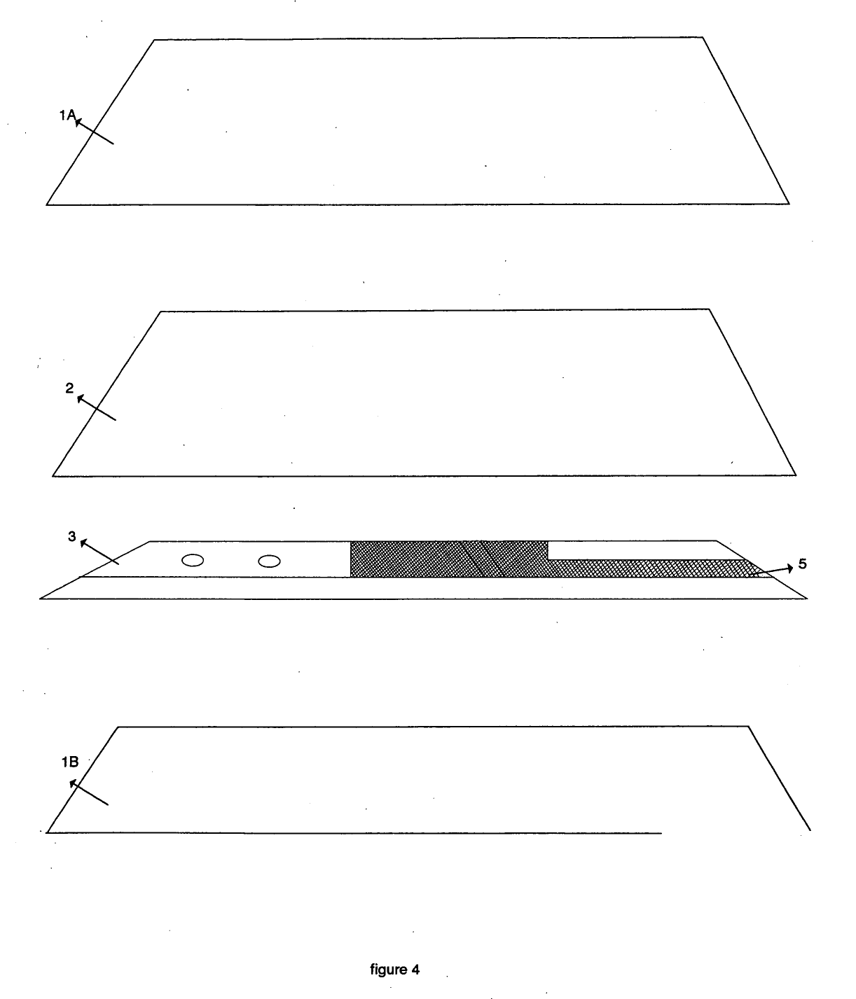

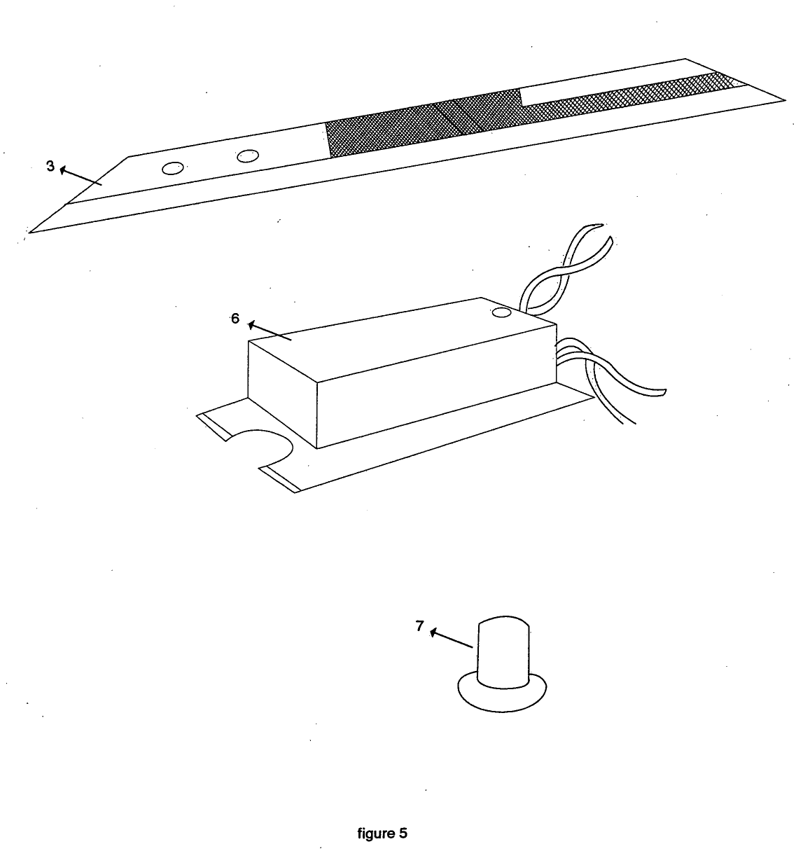

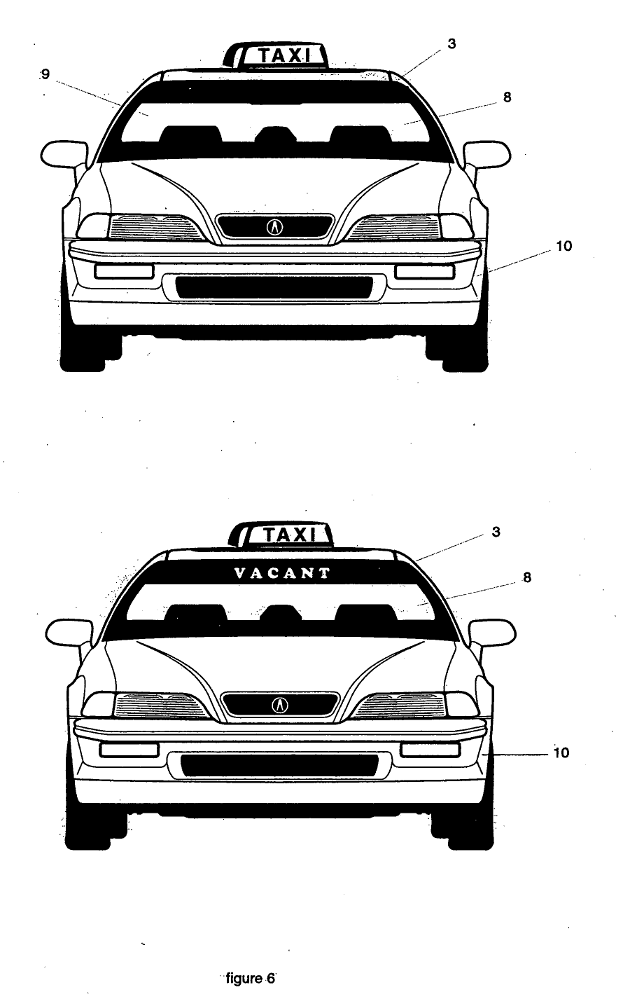

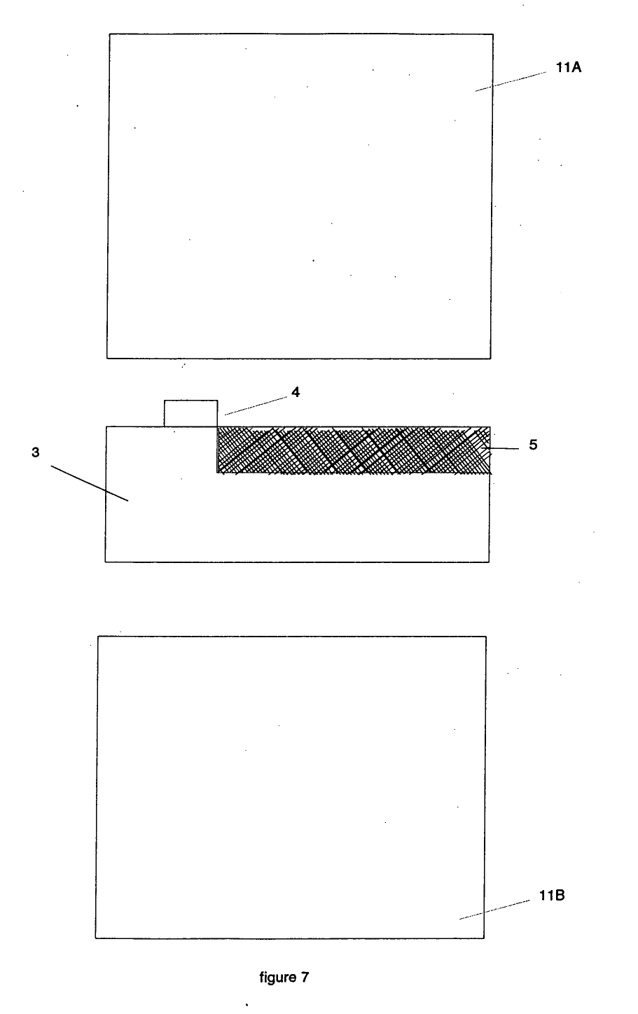

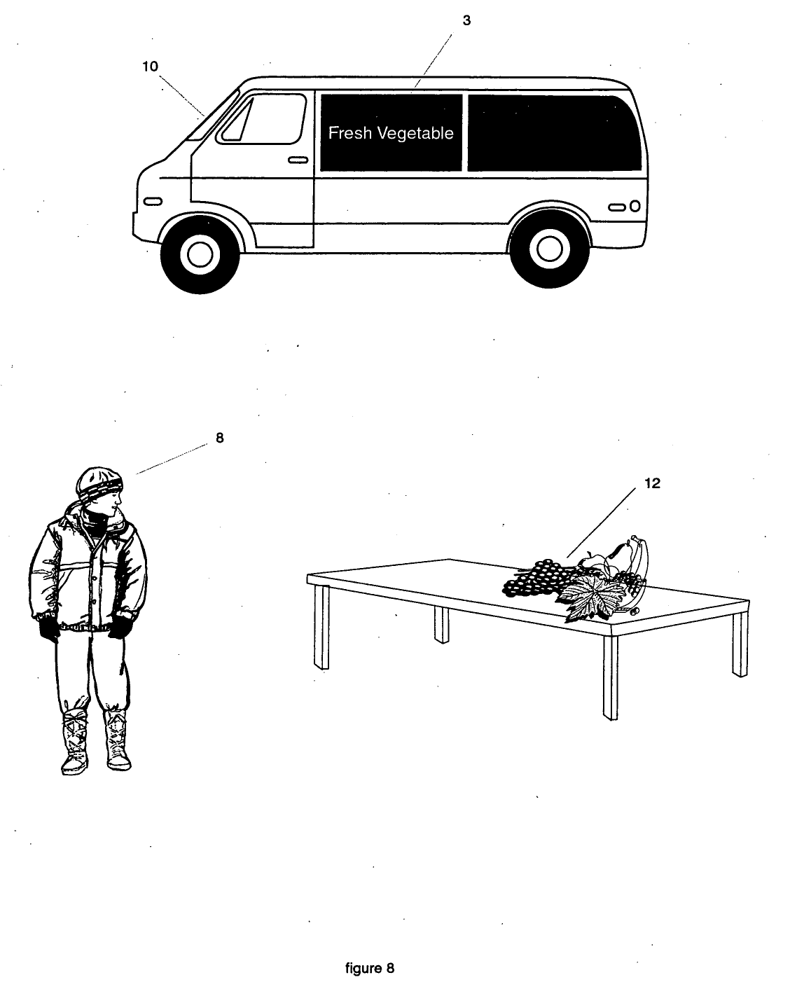

FIG. 1. Displays a whole windshield made out of two pieces of glass with a PVB layer laminated inside. FIG. 2. Displays automobile windshield glass for Visible Device 1A inner layer and 1B outer layer. There will be the same thickness in the automobile glass with this device 3 added. FIG. 3. Shows PVB layer 2 along with illuminated film 3 to be placed between the glass. FIG. 4. Displays inner layer 1A, PVB layer 2, illuminate film 3, magnetic field 4, wires connector ends 5, and outer layer 1B to be made as one whole glass laminate together. FIG. 5. Displays illuminate film 3, control panel 6, and switch 7 to operator the illuminate word. FIG. 6. Shows illuminate film 3 laminate inside windshield glass not activate, driver 8 with passenger 9 driving automobile 10. Second picture displays illuminate film 3, displaying and flashing the word VACANT laminated inside of windshield glass showing only on the outside of windshield glass, and driver 8 setting in the automobile 10 waiting for customer. FIG. 7. Displays side automobile laminate glass to be made as one whole pieces 11A & 11B with the illuminate film 3, connector end 4 and magnetic field 5 inside to advertise the Visible Device on the automobile side laminate glass. FIG. 8. Show driver 8 using the illuminate film 3 to display/flashing the Visible Device inside of automobile side laminate glass 10 to advertise to the public his/her fresh vegetables 12.

1. A device that is visual and can be seen when illuminated inside the front/back windshield glass or automobiles side glass, comprising:
an illuminate film operated by two wire connection to a computer, fuel link and starting system of an automobile;
the illuminate film is installed between an automobile glass and the wire connection hangs out when the automobile glass is manufactured;
the illuminate film will illuminate any trademark name, logo or etc. in the automobile glass.
